(19) United States
(12) Patent Application Publication
(10) Pub. No.: US 2002/0138648 A1
(43) Pub. Date: Sep. 26, 2002

(54) Hash compensation architecture and method for network address lookup

(76) Inventor: Kuang-Chih Liu, Hsinchu (TW)

Correspondence Address: BIRCH STEWART KOLASCH & BIRCH, PO BOX 747, FALLS CHURCH, VA, 22040-0747, US

(21) Appl. No.: 09/784,039

(22) Filed: Feb. 16, 2001

(51) Int. Cl. G06F 15/16; G06F 15/173

(52) U.S. Cl. 709/245; 709/238

(57) ABSTRACT

A hash compensation architecture and table lookup method is provided to efficiently lookup a valid directory entry in an address lookup table. Then, a compensation directory is implemented to store an address of a directory entry whenever an overflow occurs. When looking up an output port for an incoming packet, the lookups of the network address table and the compensation directory are performed in parallel, thereby to improve the efficiency of search. To improve the utilization of memory space, and ensure that the address of the entry indexed by the compensation directory will not affect the hash function search result, the invention further provides a translating/comparing mechanism for continuously searching a local best-fit directory entry from the outputs of the validity table and then provide for the compensation directory. Accordingly, the hash compensation mechanism and the lookup method can increase the hit rate of an address lookup for a network device and utilize the memory space more efficiently.

### BACKGROUND OF THE INVENTION

A. Field of the Invention

The present invention relates to an architecture and method for network address lookup, especially to a table lookup method for increasing the utilization of address lookup table, and improving the efficiency of table lookup with the implementation of a hash compensation scheme.

B. Description of the Related Art

In a network device, such as switch, router, bridge, etc., the switching process must operate efficiently enough because data packets arrive at closely spaced time intervals. The efficiency of the switching process is determined by several factors, such as the management of FIFO buffers, and the speed of table lookups in a forwarding engine.

Hashing techniques have been a very popular way for table lookups. For one reason, hashing techniques are efficient and easy to be implemented in an ASIC. However, the major problems with the conventional hashing techniques such as collision and overflow still occur when a new network address is hashed by a hash function into a full bucket or when two non-identical packet addresses are hashed to the same bucket, resulting in frequent lookup misses and lower performance.

To solve the collision and overflow problems, a lookup table has been implemented as a multi-way set associative cache. The lookup table is a cache directory utilized by a cache controller to access cache lines that store information from given ranges of memory addresses. Such ranges of memory addresses in memory are typically mapped into one of a plurality of sets in a cache. Each set includes a cache directory entry and an associated cache line. In addition, a tag stored in the cache directory entry for a set is used to determine whether there is a cache hit or miss for that set to verify whether the cache line in the set to which a particular memory address is mapped contains the information corresponding to that memory address.

For a multi-way set associative cache, it is usually referred to as being N-way set associative. Each “way” or class represents a separate directory entry and cache line for a given set in the cache directory. Accordingly, multi-way set associative caches, e.g., four-way set associative caches, provide multiple directory entries and cache lines to which a particular memory address may be mapped. However, when each set includes multiple directory entries, additional processing time is typically required to determine which, if any, of the multiple directory entries in the set references that memory address.

As the chance of hash collision and overflow increases, the efficiency of the packet transmission will be largely affected. For example, the packet addresses are discarded after collision or overflow, thus cannot be written into address lookup table by a learning mechanism. Furthermore, collision and overflow also cause poor memory usage because many unused buckets are left in the lookup table. As a result, hash collision and overflow results in a packet forwarding failure and inefficient use of system resources. Thus, it is desirable to provide an efficient architecture and method for hashed-based table lookup, thereby to increase the hit rate of address lookup table, and improve the utilization of memory.

### SUMMARY OF THE INVENTION

According to the problem as discussed above, it is an object of the present invention to improve the hit rate of a table lookup and the utilization of memory of a network device by providing a hash compensation architecture with a compensation directory and associated table lookup method. In accordance with the invention, the hash compensation architecture can always find the local best-fit directory entry of a set in the address lookup table with the assistance of a translating/comparing mechanism, thereby to improve the hit rate and resolve the problems of hash overflow and collision.

It is another object of the invention to provide a cost-effective hash compensation architecture and associated table lookup method which is easy to be implemented in an ASIC.

Accordingly, one aspect of the invention provides a hash compensation architecture. It includes: a hashing mechanism for generating a hash index and a compensation index in response to a network address of an incoming packet. An address lookup table is built for recording network address information and generating an associated output port for the incoming packet in response to mapping of the hash index. A validity table is established for storing valid bit information of each way of a directory entry of the address lookup table. And a translating/comparing mechanism is provided to obtain a local best-fit directory entry in the address lookup table by continuously searching and comparing each entry of the validity table according to a predetermined translated format. A compensation directory is provided for storing the local best-fit directory entry output from the translating/comparing mechanism and causing the address lookup table to generate an associated output port for the incoming packet in response to a mapping of the compensation index.

Another aspect of the invention provides a table lookup method which includes the steps of: first, generate a hash index and a compensation index at the same time in response to a network address of an incoming packet. After that, use the hash index to look up an address lookup table and cause the address lookup table to output an associated output port for forwarding the incoming packet. And then, a concurrent access of the compensation directory is performed by mapping the compensation index to the compensation directory. In response to the mapping of the compensation index, the compensation directory outputs an associated address for indexing the address lookup table and causing the address lookup table to output an associated output port for forwarding said incoming packet.

### BRIEF DESCRIPTION OF THE DRAWINGS

These and other objects and advantages of the present invention will become apparent when considered in view of the following description and accompanying drawings wherein:

FIG. 1 is a schematic diagram showing the hash compensation architecture in accordance with the preferred embodiment of the invention.

FIGS. 2A˜2C are schematic diagrams showing the translating/comparing mechanism in accordance with the preferred embodiment of the invention.

FIG. 3 is a flowchart showing the operations of the translating/comparing mechanism in accordance with the preferred embodiment of the invention.

FIG. 4 is a flowchart showing the network address learning mechanism of an address lookup table in accordance with the preferred embodiment of the invention.

FIG. 5 is a flowchart showing the table lookup method in accordance with the hash compensation architecture of the invention.

FIG. 6 is a flowchart showing the aging out processes in accordance with the preferred embodiment of the invention.

### DETAILED DESCRIPTION OF THE PREFERRED EMBODIMENT

To reduce the chances of overflow and collision in hash-based table lookups, the invention provides a non-statistical hardware implementation of the hash compensation architecture and an associated table lookup method to increase the packet forwarding speed in a network device. In general, the hash compensation architecture provides a compensation directory which is implemented as a multi-way set associative cache. Each directory entry stores address information of an address lookup table when an overflow occurred during network address learning process. In other words, the compensation directory entries store addresses for indexing to a memory location of an address lookup table to find an associated output port for an incoming packet.

On the other hand, a translating/comparing mechanism is provided to continuously search the local best-fit directory entry in the address lookup table via a concurrent access to the validity table to provide for the compensation directory. To improve the hit rate, as an incoming packet arrives, the output port for the incoming packet can be found by a concurrent access to the address lookup table and the compensation directory. Since the compensation directory and the address lookup table are operated independently, so the address lookup can be performed simultaneously and in parallel to improve the hit rate and reduce the search time.

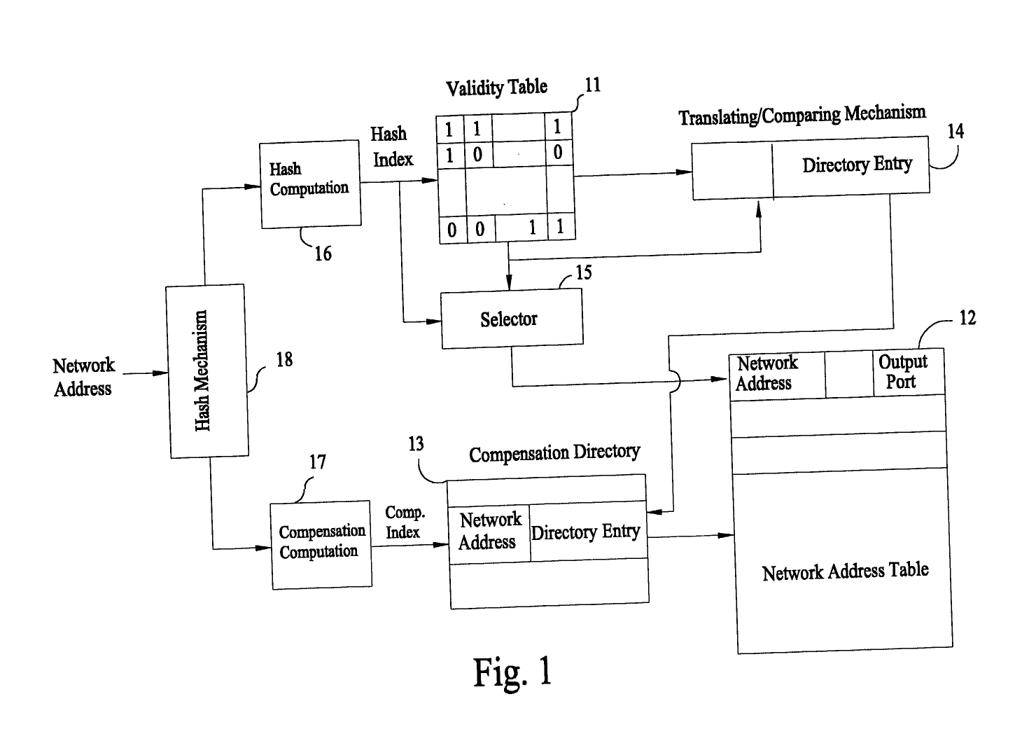

Refer to FIG. 1 for showing the hash compensation architecture according to the preferred embodiment of the invention. The address lookup table 12 contains the information of the network addresses and associated output ports. The address lookup table 12 is configured as a multi-way set associative cache. An entry of a network address X in the address lookup table 12 is obtained by computing some mathematic function ƒ. So, ƒ(X) gives the address of X in the address lookup table 12. In a multi-way set associative cache, a memory address is mapped to several directory entries and cache lines at one time. The number of “ways” or slots depends on the allowable tolerance of collisions. Each tag stored in the directory entry for a set is used as a valid bit for indicating if the associated directory entry is in use. For the convenience of operation, the valid bit in each directory entry for a set can be obtained and built as a validity table 11. Each valid bit in the validity table 11 can be mapped to an associated directory entry of a set in the address lookup table 12. A valid bit of binary “0” represents that the associated way of entry in the address lookup table 12 is invalid. From another point of view, it also means that the memory space of the associated directory entry is idle and can be provided to the compensation directory 13 for use. In contrast, a valid bit of binary “1” represents that the associated way of entry in the address lookup table 12 is in use, and thus cannot be provided to the compensation directory 13 for use.

A translating/comparing mechanism 14 is provided in connection to the validity table 11 and the compensation directory 13 for finding the local best-fit directory entry of a set in the address lookup table 12. As the network address of an incoming packet is hashed by a hashing mechanism 18 according to a mathematic algorithm or hash function 16, a hash index is generated for accessing the validity table 11 and the address lookup table 12. The valid bit of an associated directory entry in the validity table 11 mapped by the hash index is sent to a selector 15 to determine if an access to the address lookup table 12 is to be performed.

If an address lookup table 12 can store n directory entries and each directory entry of a set has k ways, then the address lookup table 12 has n×k slots. The bit-length of the associated index will be (log₂n+log₂k) bits. If E represents the xth base entry address, then the bit-length of E will be (log₂n+log₂k) bits and E=x×k. If the index is pointing to the yth way of the xth entry of a set, then the address of the yth way of the xth entry of a set will be x×k+y, where 0≦x<n and 0≦y<k.

Thus, the size of the validity table 11 will be n×k bits for storing the validity bits for the directory entries of each set. If each entry of a validity table 11 is formed by a word each of w bits, then each word can save the valid statuses of

$$\frac{w}{k}$$

entries, where k≦w. Thus, for the xth entry in an address lookup table 12, its associated address in the validity table 11 will be the

$$⌊ \frac{xk}{w} ⌋ th$$

th word. The memory address of that word will be

$$⌊ \frac{xk}{w} \times \frac{w}{8} ⌋ ,$$

that is,

$$⌊ \frac{xk}{8} ⌋$$

Accordingly, for the xth entry of a set in the address lookup table 12, its valid bit information will be saved in the

$$⌊ \frac{xk}{8} ⌋ th$$

th memory location of the validity table 11.

The network address after the computation of the hash function 16 is an entry address X of the validity table 11 and the address lookup table 12. The hashing of the network address is performed by the hashing mechanism 18 according to a hash function 16 which can be any available mathematic algorithm. On the other hand, the network address is also computed by a compensation computation 17 which can be implemented either by various hash algorithms different from the hash function 16 or as a Content Addressable Memory (CAM).

Since the access of the validity table 11 is by word, so if a word maps to multiple directory entries, each word will contain valid bit information of the desirable way of a directory entry together with the validity information of its neighboring directory entries. Such information is useful for determining if the neighboring directory entries can be provided for a compensation directory once an overflow occurs.

Thus, the invention provides a translating/comparing mechanism 14 to continuously search for the local best-fit directory entry in the network address table 12 for the compensation directory 13. The translating/comparing mechanism 14 keeps searching the validity table 11 by word to get valid bit information hit by that word. At the same time, each way of a directory entry hit by that word is translated to a predetermined format for the convenience of comparison.

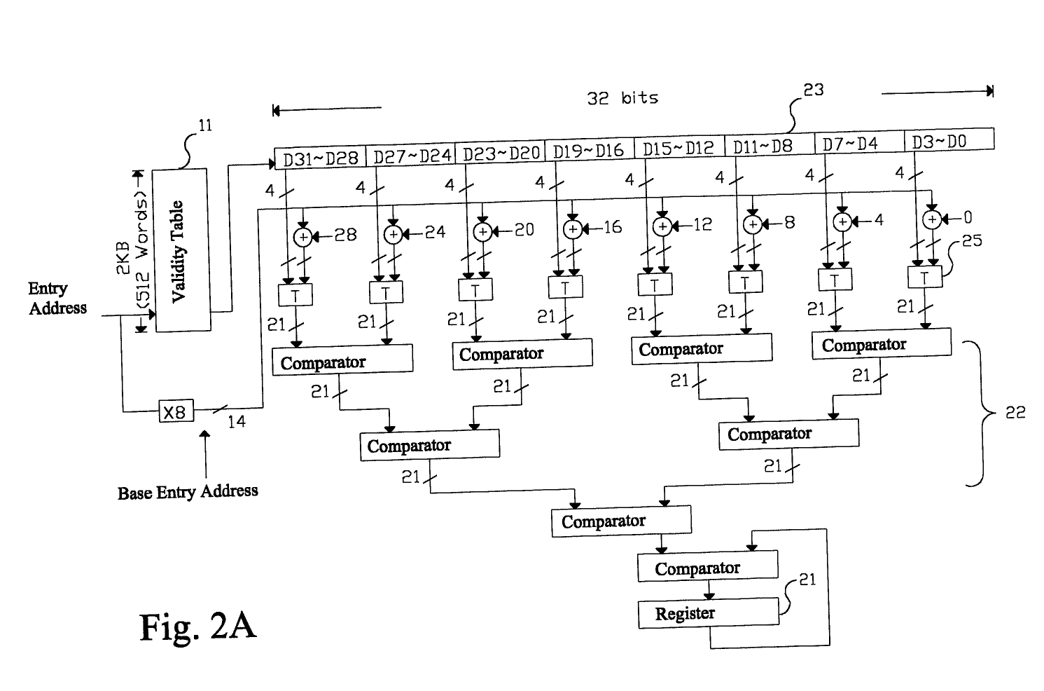

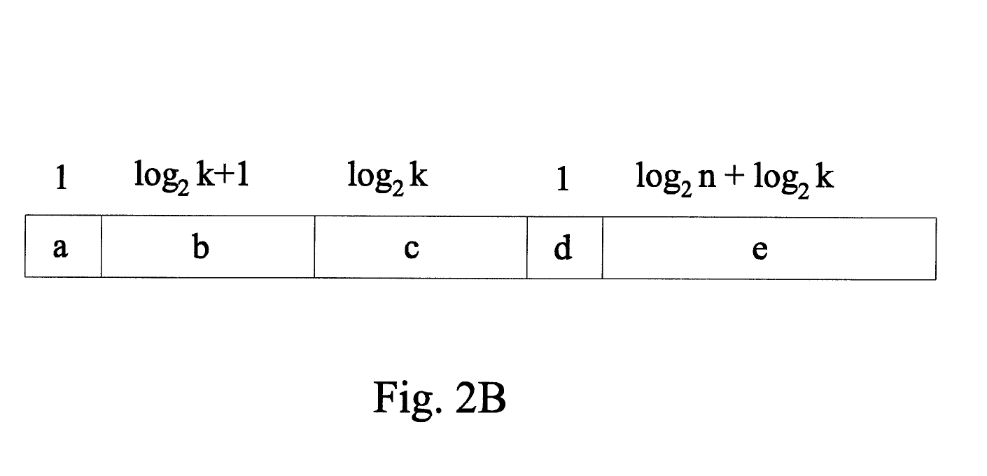

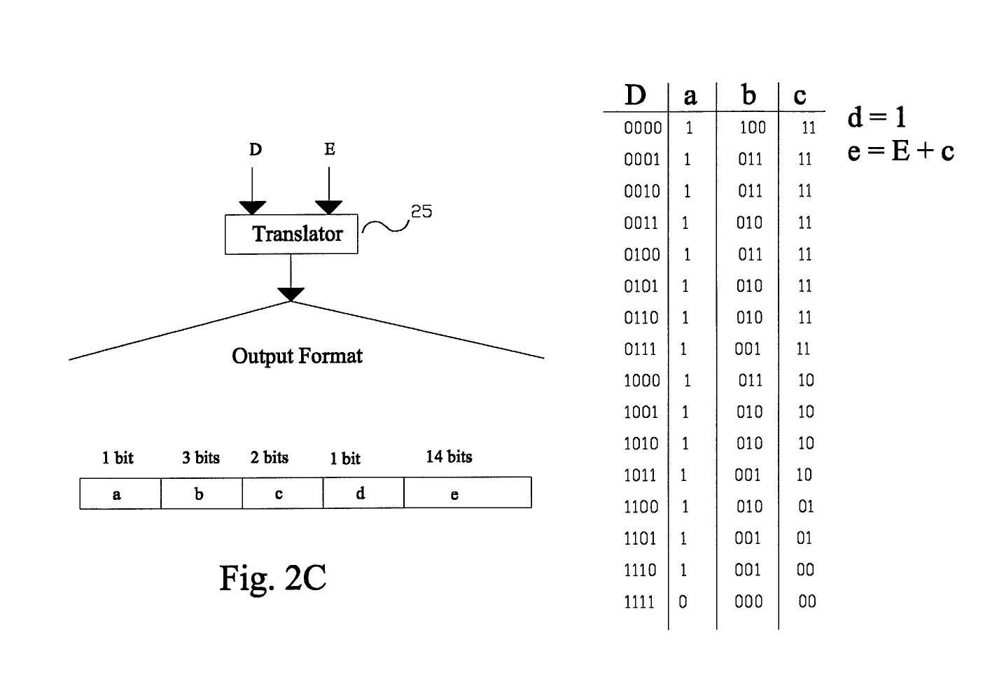

Refer to FIG. 2A for showing the structure of the translating/comparing mechanism 14. The translating/comparing mechanism 14 mainly includes a register 21 and a comparator circuit 22. The number of comparators in the comparator circuit 22 is determined by the bit-length of an entry in the validity table 11. The size of the register 21 is dependent on the size of a directory entry of a set in the address lookup table 12. Take the xth entry in the address lookup table 12 for an example. For a k-way set associative cache, each associated address in the validity table 11 has k-bit. Let D be the content of the k-bit. Let T be the translator 25 which receives two inputs, i.e., D (the content of valid bit k-bit) and E (Recall that E represents the base entry address of each entry with length of (log₂n+log₂k)-bit), as shown in FIG. 2C. Thus, the bit-length of an input will be (k+log₂n+log₂k) bits. The output of the translator 25 will generate (3+log₂n+3log₂k) bits for the register 21 to process. The output format of the translator 25 is illustrated in FIG. 2B. Each segment in the output format from a to e represents: 1 bit, log₂k+1 bit, log₂k bit, 1 bit, and log₂n+log₂k bit, respectively. Each segment is defined as follows:

(a) segment a is a compensation bit for indicating if there is an empty slot in each D. If yes, set a=1. If not, set a=0.

(b) segment b is a counter field for indicating the number of binary “0”s in each D, and counting the number of empty slots in each D.

(c) segment c is a selection field for storing the order of the leftmost “1” of the address stored in the address field, counting from 0.

(d) segment d is a source field for indicating the provider of the address stored in the address field. If the translator 25 is enabled by the translating/comparing mechanism 14, then set the segment d to 1. Otherwise, set the segment d to 0.

(e) segment e is an address field for recording the address of the directory entry provided for compensation. Its value will be E+c, representing the base entry address E plus the highest available directory entry c.

Take a four-way set associative cache for an example, if the size of an address lookup table 12 is 16K(1024×24), which includes 4K(2¹²) entries and each set has four “ways” or directory entries. In that case, the size of the register 21 will be 21 bits. From MSB to LSB, each segment of the register 21 will be:

The 20th bit is defined as (a).

The 19th˜17th bits are defined as (b).

The 16th˜15th bit are defined as (c).

The 14th bit is defined as (d).

The 13˜0 bits are defined as (e).

As described above, the source bit d is 1 bit, which can represent the source of the directory entry in the register 21. If the source is from the translating/comparing mechanism 14, then the source bit will be set to “1”. On the other hand, if the source is obtained by table lookup or learning, then the source bit will be set to “0”. The structure of the translating/comparing mechanism 14 is illustrated in FIG. 2A. The length of D is 4 bits, and the length of E is 14 bits. The output of the translator 25 is 21 bits in length to provide for the register 21. The size of the register 21 is dependent on the size of the address lookup table 12. The operation and output format of the register 21 is illustrated in FIG. 2C.

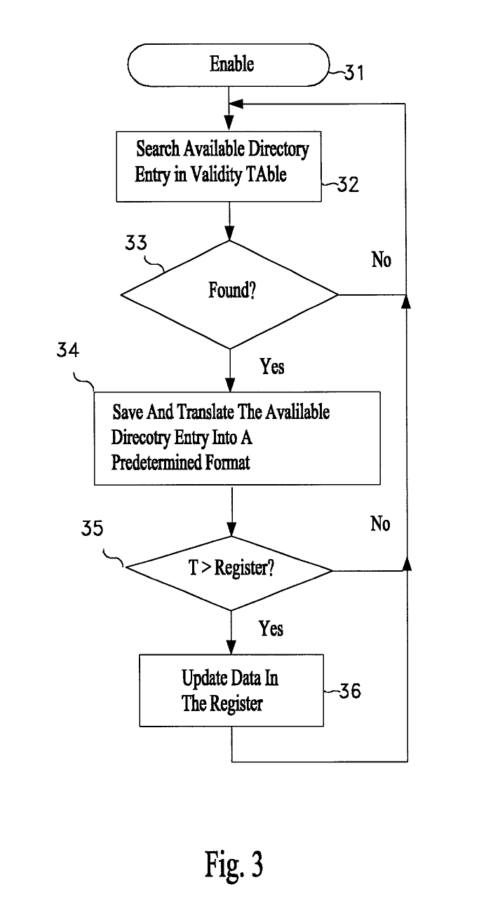

The operations of the translating/comparing mechanism 14 are illustrated in FIG. 3. The translating/comparing mechanism 14 continuously searches the validity table 11 and translating each entry mapped by a word into a format for comparison to find out a local best-fit directory entry, step 31. Search the entire validity table 11 and determine if there is any available directory entry, step 32. If yes, record the information of the available directory entry address and compare the available entry address with the content of the register 21 after being translated by the translator 14, step 34. Determine if the translated result of the directory entry address is larger than the content of the register 21? Step 35. If yes, it means that the new directory entry address is better than the previous one stored in the register 21, so go to step 36 to update the data stored in the register 21. If not, go to step 32, to continue the comparison procedure.

The preferred embodiment of the translating/comparing mechanism 14 is illustrated in FIGS. 2A˜2C. Refer to FIG. 2A again, a mapped directory entry 23 consists of 32 bits which is logically partitioned into 8 segments D, each with 4 bits. Each segment of the mapped entry is translated to a predetermined format by a translator (T) 25 and then input to a comparator circuit 22 to find out a local best-fit directory entry. If the segment selected by comparator circuit 22 contains a number larger than the number stored in the register 21, go to step 36 to update the data of the register 21. After step 36, go to step 32 to continue the translating and comparing procedure. Steps 32 to 36 are repeatedly executed once the system is enabled.

When an overflow occurs, the address of the local best-fit directory entry is obtained from the register 14 and then stored in the compensation directory 13 as an index for searching the address lookup table 12. The packet address is hashed simultaneously by the hash computation 16 and the compensation computation 17 for table lookup. If a collision occurs for a network address when using the hash index generated by the hash computation 16, it is also possible to find a bucket in the address lookup table 12 via the index of the compensation directory 13. In other words, the compensation directory 13 can provide an index pointing to the address lookup table 12 timely before any over-write policy is taken place, such as LRU.

In addition to the continuously searching, translating and comparing procedure of the translating/comparing mechanism 14, the entry of the validity table 11 hit by the word for address lookup, learning, CPU Read/Write, aging out, etc. can also be provided to the register 21 to find the local best-fit address for the compensation directory 13. Under such a condition, the segment d of the output of the translator 25 will be “0”.

The data structure of the compensation directory 13 includes: network address, and directory entry of a set for storing the overflow data of the validity table after hash collision. The compensation directory 13 can be implemented as a Content Addressable Memory (CAM), by a tree-based architecture, or based on a hash algorithm. It all depends on the compensation computation 17. If the network address is directly mapped to the compensation directory 13, then the compensation directory 13 is like a CAM implementation. No matter how, the operation principles for implementing the compensation directory 13 is basically the same.

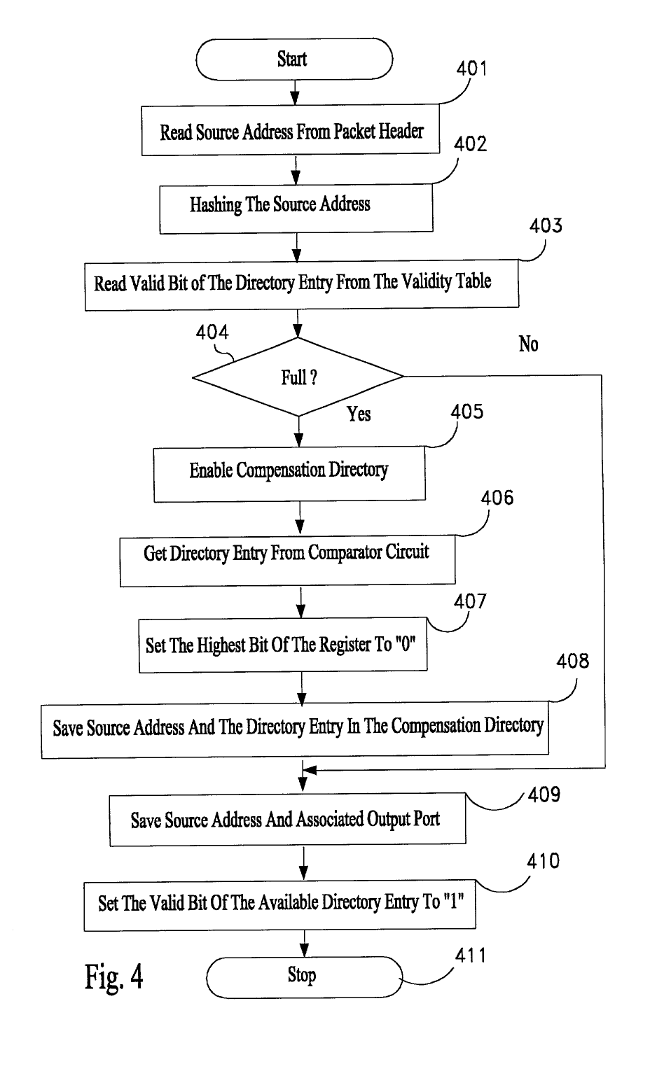

According to the above-described structure, the invention can readily use the address of the available directory entry via the learning mechanism of the network address. Refer to FIG. 4 for showing the learning mechanism of the invention. After receiving a packet, the source address can be obtained from the packet header, step 401. Then, perform a hash computation 16 to find the address of the directory entry of a set in the address lookup table 12, step 402. After that, read the valid bit of each directory entry of a set from the validity table 11, step 403. Determine if the valid bit of each directory entry of a set is already taken? Step 404. If yes, go to step 405. If not, go to step 409.

If each directory entry of a set has already been taken, it means that a collision or an overflow occurs. In that case, enable the compensation directory 13 and try to access the remaining directory entry of a set available in the address lookup table 12, step 405. Get the local best-fit directory entry of a set from the register 21 of the translating/comparing mechanism 14, step 406. After that, set the highest bit (i.e. MSB of segment a) of the register 21 in the translating/comparing mechanism 14 to “0” to indicate that a directory entry of a set in the address lookup table 12 indexed by the address from the register 21 has already been taken, step 407. Thus, the source network address and the associated directory entry provided by the register 21 can be saved in the compensation directory at a location based on the computation result of the compensation computation 17 or by CAM, step 408.

If the directory entry of a set is not full, or the procedure performed by step 408 is finished, then simply save the source network address and associated output port information into the directory entry of a set in the address lookup table, step 409. After that, set the valid bit of the associated directory entry to “1” to indicate that the associated directory entry has been taken, step 410. Then, stop the learning mechanism of packet address.

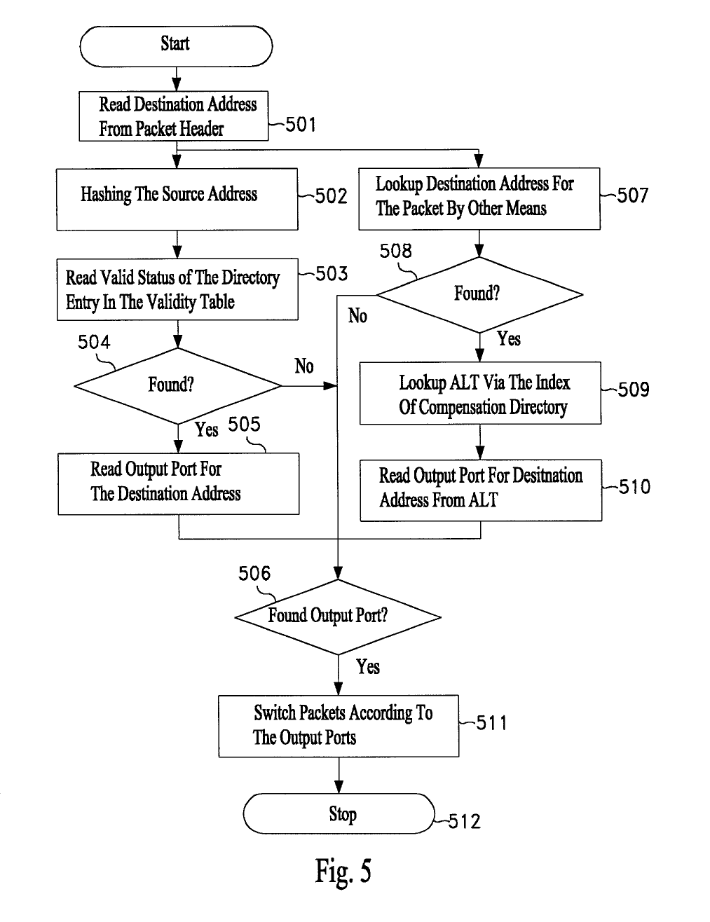

FIG. 5 shows the table lookup method of the invention using the hash compensation architecture. First, get the destination network address from the packet header, step 501. Then, search the address lookup table 12 and compensation directory 13 in parallel to increase the efficiency of table lookup.

When looking up the address lookup table 12, use the hash computation 16 to find the corresponding directory entry of a set in the address lookup table 12 for the incoming packet, step 502. After that, read each valid bit from the validity table 13, step 503. Then, search for the available directory entry of a set and determine if the associated network address has been found, Step 504. If yes, go to step 505 to read the correspondent output port of that destination network address from the address lookup table 12. If not, go to step 506.

On the other hand, use another hash function algorithm or use CAM to lookup the compensation directory 13 for finding the destination network address of the incoming packet, step 507. Determine if the destination network address is saved in the compensation directory 13? Step 508. If yes, go to step 509. If not, go to step 506.

Step 509, since the destination network address of the incoming packet can be found in the compensation directory 13, so read the address of the address lookup table 12 from the compensation directory 13. And then, use that address as an index to read the information actually stored in the address lookup table 12. And then, read the output port of that correspondent destination network address from the address lookup table 12, step 510. And then, go to step 506.

Step 506, determine if the output port can be found from the address lookup table 12 or the compensation directory 13? If yes, go to step 511 to forward the packet according to the output port found. If not, go to step 512 to stop the lookup mechanism.

Accordingly, when an incoming packet arrives for table lookup. Its address can be mapped to the address lookup table 12 for table lookup via hash computation 16 and simultaneously mapped to the compensation directory 13 via compensation computation 17. As soon as an address is found in the either the address lookup table 12 or the compensation directory 13, there is a hit. So, the hit rate has been increased. A lookup miss will occur only when there is no hit in both the compensation directory 13 and the address lookup table 12.

The compensation architecture of the invention also needs to take the problem of aging out and compensation occupation into account. Aging out refers to the process for periodically deleting the time-out invalid data stored in the address lookup table 12 to save the memory space. When the data in the directory entry of the address lookup table 12 is time-out, and if that data is indexed by the compensation directory 13, then the deletion of that time-out data in the address lookup table 12 must be performed by the compensation directory 13 to prevent the inconsistency between the address lookup table 12 and the compensation directory 13. The compensation directory 13 deletes the time-out data by resetting the valid bit in the associated directory entry of the validity table 11.

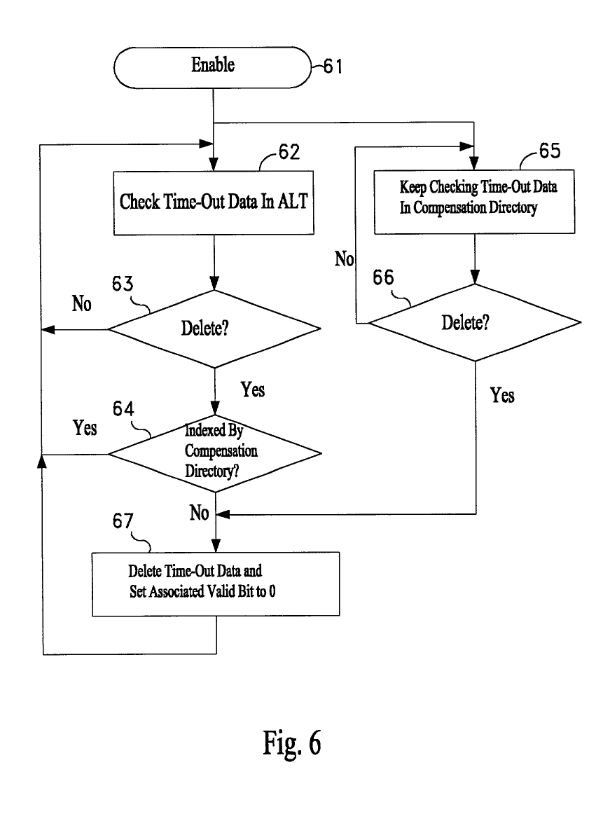

The aging out process of the compensation directory 13 is illustrated in FIG. 6. The compensation directory 13 will periodically delete time-out data, step 61. Since the time-out data exists in both the address lookup table 12 and compensation directory 13, so the aging out checking process is performed at both sides. On the part of address lookup table 12, first check the time-out information in the address lookup table 12, step 62. Determine if the time-out data is to be deleted? Step 63. If yes, go to step 64 to further determine if the time-out data is indexed by the compensation directory 13? If yes, go to step 62 to continue searching for another time-out data and skip the current directory entry.

On the part of the compensation directory 13, keep checking the time-out information in the compensation directory 13, step 65. Determine if the time-out data is to be deleted? Step 66. If not necessary, go to step 65 to continue searching for a time-out data. If not, go to step 67 to delete the time-out data and set the correspondent valid bit in the validity table 11 to “0” for indicating that the current status of that entry is idle.

On the other hand, if the time-out data is not indexed by the compensation directory 13, and the compensation directory 13 is not enabled, then the time-out data can be directly deleted, and set the correspondent valid bit in the validity table 11 as “0”, step 67. Then, go to step 62.

Furthermore, since the directory entry indexed by the compensation directory 13 may collide with a hash result of the original hash computation 16, it may increase the chance of collision, which is referred to as a “push-out effect”. However, such a push-out effect will be beneficial if controlled under a tolerable range. Since a directory entry of a set pushed out from the address lookup table 12 will be stored in the compensation directory 13, so the table lookup for an incoming packet will be actually performed in parallel. As a result, the search speed is increased. However, too many directory entries pushed out will consume lots of memory space in the compensation directory 13. Thus, it is necessary to prevent such a situation.

To solve this problem, the invention provides a “compensated stealing” approach. That is, increase the valid bit to two bits. For instance, let “11” indicate that the entry is not-compensated and normally in use, “00” idle, “01” compensated stealing, and “10” compensated occupied. When the compensation directory 13 gets an available directory entry of a set from the address lookup table 12, it will not set the associated valid bits in the validity table to “11” or “10”, instead, they are set as “01”. Once a collision occurs, if the content is “01”, it depends on whether the record will be overwritten to determine the subsequent actions. Thus, the push-out effect can be prevented.

To sum up, the hash compensation architecture and associated lookup method provided by the invention can improve the hit rate and improve the utilization of memory space with the implementation of the translating/comparing mechanism and compensation directory. Moreover, the output format of the translators is convenient and efficient for address comparison to find the local best-fit directory entry in the validity table, thereby to increase the lookup speed, and reduce the chance of hash collisions. Furthermore, although the invention is described in connection with a data packet switch, the scheme of the inventive method and hash compensation architecture can also be implemented as an ASIC and widely adapted to ISO layer-2, layer-3, layer-4 table lookups.

In addition, any person skilled in the art can provide some modifications based on the spirit of the invention. For instance, the memory space of the address lookup table can be physically partitioned into two parts, X and Y, and then implement two translating/comparing mechanisms for X and Y respectively for obtaining the local best-fit directory entry of a set. When a hash collision occurs in memory X, compensation directory can use the entry provided by register Y for compensation. Thus, the hash function for network address table lookup and compensation directory lookup are performed completely in parallel and concurrently because memory X and Y are independent memory modules.

While this invention has been described with reference to an illustrative embodiment, this description is not intended to be construed in a limiting sense. Various modifications and combinations of the illustrative embodiment, as well as other embodiments of the invention, will be apparent to persons skilled in the art upon reference to the description. It is therefore intended that the appended claims encompass any such modifications or embodiments.

What is claimed is:

1. A hash compensation architecture for a network device, comprising:
a hashing mechanism for generating a hash index and a compensation index in response to a network address of an incoming packet;
an address lookup table for recording network address information and generating an associated output port for said incoming packet in response to said hash index;
a validity table for storing valid bit information of each directory entry of said address lookup table;
a translating/comparing mechanism coupled to said validity table for obtaining a local best-fit directory entry in said address lookup table by continuously translating and comparing each directory entry of said validity table according to a predetermined format; and
a compensation directory coupled to said translating/comparing mechanism for storing said local best-fit directory entry output from said translating/comparing mechanism and causing said address lookup table to generate an associated output port for said incoming packet in response to a mapping of said compensation index.

2. The hash compensation architecture for a network device as claimed in claim 1, wherein said translating/comparing mechanism comprises:
a plurality of translators each for receiving k-bit valid bits input and an address of a valid directory entry of a set and generating an output in accordance with said predetermined format, said predetermined format defined by:
an address field for storing an address of a directory entry of a set;
a compensation field for indicating if an address stored in said address field can be provided for said compensation directory;
a counter field for indicating the number of valid directory entries of a set mapped by said address stored in said address field;
a selection field for indicating the order of the leftmost “1” of a valid directory entry mapped by said address stored in said address field; and
a source field for indicating the provider of said address stored in said address field;
a comparator circuit for continuously comparing the outputs of said plurality of translators and selecting an output with a local best-fit directory entry; and
means for storing said output with a local best-fit directory entry.

3. The hash compensation architecture for a network device as claimed in claim 1, wherein said compensation directory comprises:
a plurality of directory entries and associated network addresses for indexing said address lookup table.

4. The hash compensation architecture for a network device as claimed in claim 1, wherein said valid bit information of said validity table is at least 1 bit.

5. The hash compensation architecture for a network device as claimed in claim 1, wherein said compensation directory periodically performs an aging out process.

6. The hash compensation architecture for a network device as claimed in claim 5, wherein said address lookup table periodically performs an aging out process on any directory entry which is currently not indexed by said compensation directory.

7. The hash compensation architecture for a network device as claimed in claim 1, wherein said valid bit information of said validity table is two-bit for representing the statuses of not-compensated, idle, compensated steeling, and compensated occupied.

8. In a network device having a hash compensation architecture, a method for looking up an address lookup table c comprising the steps of:
concurrently generating a hash index and a compensation index in response to a network address of an incoming packet;
using said hash index to look up an address lookup table and cause said address lookup table to output an associated output port for forwarding said incoming packet; and
simultaneously using said compensation index to lookup a compensation directory and cause said compensation directory to output an associated address for indexing said address lookup table and causing said address lookup table to output an associated output port for forwarding said incoming packet.

9. The method for looking up an address lookup table as claimed in claim 8, wherein said compensation directory stores data from said address lookup table when an overflow occurs while said address lookup table is performing network address learning.

10. The method for looking up an address lookup table as claimed in claim 8, further comprising the steps of:
building a validity table according to valid bit information of each directory entry of a set in said address lookup table;
continuously searching and translating each entry of said validity table entry into a predetermined format for comparison;
selecting a local best-fit directory entry from each comparison result of said searching and translating step; and
storing a local best-fit directory entry to provide for said compensation directory .

11. The method for looking up an address lookup table as claimed in claim 8, further comprising the step of:
periodically performing an aging out process for said compensation directory.

12. The method for looking up an address lookup table as claimed in claim 8, further comprising the steps of:
directly deleting any directory entry of said address lookup table when said directory entry is time-out and not recorded in said compensation directory; and
deleting any directory entry in said compensation directory when said directory entry is time-out and recorded in said compensation directory.
